(19) United States
(12) Patent Application Publication
(10) Pub. No.: US 2004/0194976 A1
(43) Pub. Date: Oct. 7, 2004

(54) Fire protection unit with glass vessel sensors

(76) Inventor: Alex Kretzschmar, Magdeburg (DE)

Correspondence Address: Law Offices of Karl Hormann, PO Box 381516, Cambridge, MA, 02238-1516, US

(21) Appl. No.: 10/416,280

(22) PCT Filed: Nov. 5, 2001
(86) PCT No.: PCT/DE01/04194

(30) Foreign Application Priority Data
Nov. 16, 2000 (DE) 10056778.9

(51) Int. Cl. A62C 37/36

(52) U.S. Cl. 169/42

(57) ABSTRACT

The invention relates to a fire protection unit with glass vessel sensors, for example for sprinkler units, which open the extinguishing agent releasing openings in the case of fire and which comprise a glass vessel, filled with a liquid and retained by a housing, which may be broken by a control unit by means of a remote electrical actuator. The aim of the invention is to achieve an economical fire protection unit with the high safety standards of extinguisher units controlled by fore alarm units, but without the complexity thereof. In particular, a rapid detection and localization of the fire should be possible and also the immediate opening of the extinguishing agent release openings necessary for limiting or eliminating the fire. The maintenance requirement should be as limited as for sprinkler units. Said aim is achieved, whereby the remote electrical actuator is embodied as sensor for recording the state of the glass vessel (1). Conventional glass vessel sensors thus become sensors which can be interrogated and sprinklers become intelligent fire alarms.

### BACKGROUND OF THE INVENTION

1. Field of the Invention

The invention relates to a fire protection system with glass vessel sensors, for use, for instance, with sprinkler systems which in case of a fire open discharge openings for the release of fire quenching agents.

2. The Prior Art

In connection with fire extinction technology it is known to activate sprinkler and quenching systems by glass vessel sensors. Such sensors are provided with a small glass vessel containing a liquid. By way of a gasket, the small glass vessel is pressed against, and seals, the opening of the sprinkler or of a conduit filled with a medium. Its principle is that as the liquid contained in the small vessel is being heated, the pressure in the vessel will increase sufficiently to cause the vessel to burst, leading to opening the opening of the sprinkler or of the pipe conduit. The quenching agent is instantaneously discharged or, in case of dry quenching systems, it is fed to the discharge opening for the quenching agent. The resultant pressure drop in the system controls the system, starting up and pumps for the further supply of quenching agent. Essential criteria for the effectiveness and reliability of such systems are the release temperature and the response time of such of the glass vessel sensors. The vapor pressure of the liquid enclosed in the small glass vessel or the size of the bubble determines the release temperature level; the response time is determined by the diameter of the small glass vessel. In several actual cases it was shown, however, that the responsiveness of the glass vessel sensors is insufficient. During the interval between the beginning of a conflagration and the destruction of the glass vessel sensor by hot gases, the conflagration spreads unimpededly. For this reason, fire alarm systems have been developed the sensors of which are more sensitive than those reacting to the heating of glass vessel sensors. Thus, it is known constantly to analyze the air within a room and to release a signal at the detection of the least trace of conflagration gas. Other systems monitor the development of temperature in a space, such that a fire alarm signal and/or quenching signal is released at the occurrence of an inadmissible temperature gradient. To quench a fire, such fire alarm systems must always be connected to a quenching system. However, the increased safety attained by the combination of a fire alarm system and a quenching system leads to a substantially greater complexity than do conventional sprinkler systems. In particular, the super-sensitive fire alarm systems render such fire protection systems very expensive, so that they are only utilized in connection with objects worthy of protection. In praxi, it is mainly sprinkler systems which are employed for fire protection.

Aside from the sluggish responsiveness of the glass vessel sensors described above, systems activated by sprinklers suffer from yet another disadvantage. The quench agent discharge openings sealed by the glass vessel sensors limit the spreading of quench agent over a limited area only, so that the discharging quench agent often does not cover the entire site of a conflagration. On the other hand, because of certain flow conditions conflagration gasses may reach and release glass vessel sensors which are not directly positioned over a conflagration site. This neither quenches nor restricts the conflagration. Similar occurrences, albeit of lesser gravity, were also observed on glass vessel controlled valves which then release groups of sprinklers or other groups of quench agent discharge devices, such as, for instance, high pressure spray heads. Without an additional fire alarm system furnishing data regarding the precise location of the conflagration, this disadvantage may only be counteracted, once one sprinkler has been released, by opening, as a precautionary measure, all quench agent discharge devices fed by the same quench agent feed conduit. In the case of sprinkler systems, this would, however, require a remote-controlled mechanical destruction of the glass vessel sensors in order to release the quench agent discharge devices. Sprinklers suitable for this purpose would be those of the Danish trademark GW-DD1-EL, in which a Metron actuator destroys the glass vessel sensor by electric actuation within 10 milliseconds. The disadvantage of such electrically released sprinklers is the complexity of their fabrication and the resultant high cost. Furthermore, the components, such as coil housing and plunger, required for mechanically destroying the small glass vessel interfere with the spreading of the quench agent. A further disadvantage of such sprinkler system is that in the case of a fire they require large quantities of water which leads to disproportionately great water damage. The release by electric remote control of a lesser number of sprinklers, such as those sprinklers, for instance, which are positioned in the immediate vicinity of the thermally actuated glass vessel, again requires an exact detection of the site of the fire, for which purpose, as has been mentioned supra, only the expensive fire alarm systems are currently available. These would also solve the problem inherent in sprinkler systems and described above, of the insufficient areal or spatial conformance of detection and quenching areas.

### OBJECT OF THE INVENTION

Therefore, the object of the invention is to provide a cost-efficient fire protection system which while being of the high standard as regards the safety and reliability of powerful quenching systems controlled by fire alarm systems avoids their complexity. More particularly, it is to be possible quickly to detect and localize the site of a fire as well as instantaneously to open the quench agent discharge openings required for limiting or liquidating a fire, without a significant increase in complexity while adhering to the principle of releasing the quench agent by means of a glass vessel sensor. The complexity of maintenance is to be similar to that of sprinkler systems.

### BRIEF SUMMARY OF THE INVENTION.

In accordance with the invention, the object is accomplished by the characteristics of the first patent claim. All further patent claims relate to special embodiments of the glass vessel sensor in accordance with the invention.

The inventive retooling of conventional glass vessel sensors to sensors which can be polled converts sprinklers into intelligent fire alarms and, therefore, sprinkler systems to quenching systems. Whereas hitherto sprinklers used to seal, and in case of a fire opened, quench agent discharge openings only in the manner of thermal threshold switches, they are now capable at any point in time and upon request to provide data about their condition. Accordingly, it can bee seen at the control unit of the fire protection system which one of the glass vessel sensors is still whole, the prevailing temperature gradient and which one of the glass vessel sensors has by thermal actuation released a quench agent discharge opening. An important advantage of the invention resides in the fact that with little technical complexity a sprinkler is capable of providing feed-back for determining an approach to limiting or liquidating a conflagration. In combination with the possibility of destroying by the glass vessel sensors remote control at any time, the sprinkler systems or sprinkler controlled quench systems thus achieve high reliability and efficiency. Additional fire alarm systems are unnecessary, so that cost-efficient fire protection systems and quench systems become available. Thus, it is now possible for effective fire fighting, after actuation of a sprinkler to actuate all sprinklers in its vicinity. By monitoring the temperature gradients, sprinklers may be actuated sooner than would be possible solely by their thermal responsiveness in consequence of the room temperature prevailing in their vicinity. The fire fighting which thus commences earlier increases the chances of safely liquidating a conflagration in its initial phase.

Since except for the utilized sensor elements and their electrical feed lines, which drop off during the destruction of the little glass vessel, there are no other components on the sprinkler, the quench agent may be unimpededly discharged from the released opening.

Technically, the glass vessel sensor may be structured in several different ways. For instance, a heating element may be provided at or in the glass vessel for heating the liquid contained therein. Equally suitable heating elements are, for instance, resistance heating wires and thermal elements. Both variants offer the possibility of monitoring the temperature of the liquid.

There are different ways of connecting the glass vessel and sensor element. In the simplest case, a heating element is clamped to the outside of the glass vessel. It is also possible adhesively to attach the sensor element to the wall of the vessel by a heat-resistant adhesive. Where the heating element is integrated in the glass vessel, or fed through the interior thereof, during manufacture of the vessel, such glass vessels sensor are of high sensitivity and responsiveness.

It is, of course, also possible to derive data relating to the condition of the glass vessel mechanically by pressure sensors. For this purpose, the mechanically movable plungers of known electrically actuable sprinklers are controlled such that they are also suitable for mechanically engaging the glass vessel. However, such sprinklers require an additional sensor for temperature monitoring.

### DESCRIPTION OF THE SEVERAL DRAWINGS

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawings, in which:

FIG. 1 depicts a glass vessel sensor including a heating element embracing the glass tube;

FIG. 2 is a cross-sectional view of the sensor of FIG. 1;

FIG. 3 depicts a glass vessel sensor including a thermal element in the liquid;

FIG. 4 depicts a glass vessel sensor including a heating coil disposed in the liquid;

FIG. 5 is a cross-sectional view of the glass vessel sensor of FIG. 4;

FIG. 6 is a cross-sectional view of a glass vessel sensor with a thermal element integrated in the wall of the glass vessel;

FIG. 7 is a cross-sectional view of a glass vessel sensor with a resistance heating wire integrated in the wall of the glass vessel;

FIG. 8 shows a glass vessel sensor with mechanical key; and

FIG. 9 depicts a glass vessel sensor installed in a sprinkler.

### DETAILED DESCRIPTION OF THE PREFERRED EMBODIMENTS

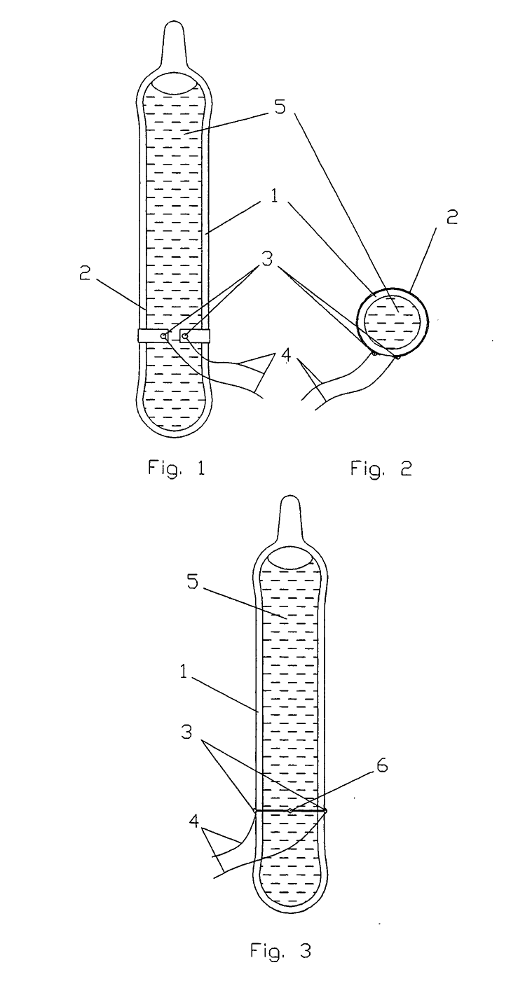

In the simplest case, glass vessel sensors are equipped or retrofitted with heating elements. In this connection, FIGS. 1 and 2 show that an annular heating element 2 has been mounted on a glass tube 1 at the lower third section thereof. The heating element 2 is arranged at the lower third section of the glass tube 1 because of ascending heat. It is structured as an open ring the internal diameter of which is slightly smaller than the outer diameter of the glass tube 1, and it consists of an electrically conductive elastic material. In the initial state, the two edges formed by dividing the ring may touch each other or be spaced slightly apart. On each side of the division the heating element 2 is provided with electrical connectors 3 releasably connected to electrical conductors 4. When the heating element is pushed onto the glass tube 1, it is slightly expanded, and when resiliently contracting it will securely clamp to the glass tube 1 so that the two edges with their connectors 3 will no longer touch each other. When the liquid 5 enclosed in the glass tube 1 is heated such that the glass tube 1 bursts, the heating element 2 will drop off and separate itself from its conductors 4. At that instant the resistance between the two connectors 3 measured over the conductors 4 changes. This change in resistance signals that the glass vessel sensor has opened the quench agent discharge opening. For safety reasons, all glass vessel sensors in its immediate vicinity may now be heated up by their heating elements 2 until the vessels burst and release their quench agent discharge openings as well. In that case, the required energy is fed to the heating elements 2 by way of the electrical conductors 4 which until this instant have served as signal feed lines. Thus, the arrangement releases a signal only after the destruction of at least one glass tube 1. It cannot, however, furnish data regarding the actual temperature of the liquid 5 in the glass tube 1. For that purpose, the glass tubes 1 have to be equipped with temperature sensitive sensors. In this respect, FIG. 3 depicts a thermal element 6 extending through the glass tube 1. It is thus positioned in the liquid 5. Connectors 3 are provided at the exterior of the glass tube 1 for releasable connection with the electrical conductors 4. A resistance wire may be used instead of the thermal element 6. The temperature of the liquid 5 in the glass tube 1 is constantly monitored over the electrical conductors 4. When a critical temperature has been reached, heating current may be fed over the electrical conductors 4 so that the liquid will, within a short time, reach a temperature causing the glass tube 1 to burst. Thereafter, as already described, all glass tubes 1 in the immediate vicinity may be heated to burst in order to ensure that the fire is fought in an effective manner. A further advantage of this embodiment is that as the glass tube 1 bursts, the conductors 4 are at the same time severed from their connectors 3 ensuring improved generation of the release signal and its faster transmission to the a control center than would be the case of the clamped heating element 2 simply dropping off the glass tube 1 as described in connection with FIGS. 1 and 2.

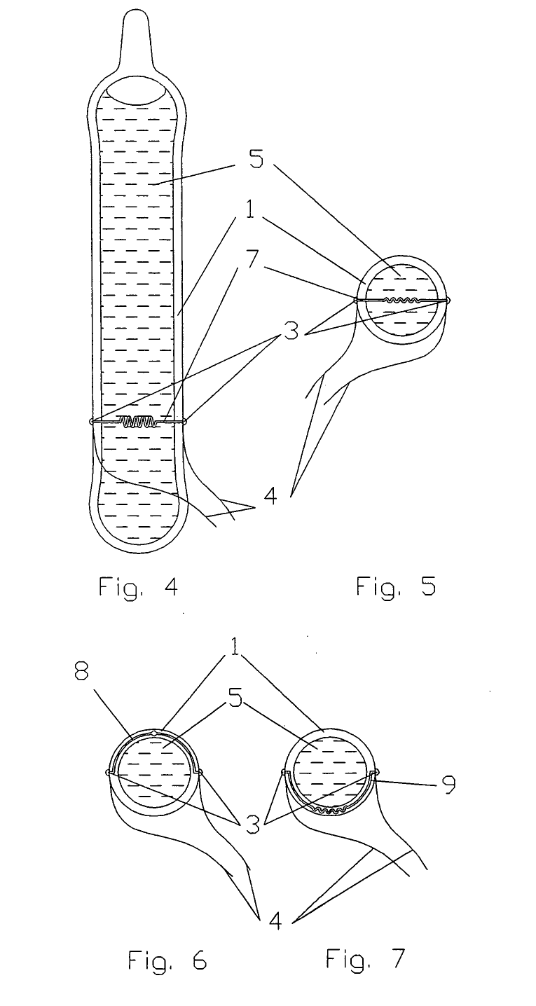

Heating of the liquid 5 in the glass tube 1 substantially faster than is possible by a heating element 2 mounted on the exterior of the glass tube 1 or by a thermal element 5 disposed in the liquid 5 is achieved by a heating coil 7 provided directly in the glass tube 1, as shown in FIGS. 4 and 5. In a manner similar to the thermal element 6 shown in FIG. 3, the connections 3 of the heating coil 7 are also guided through the wall of the glass tube 1 and are connected to the conductors 4 in an easily severable manner.

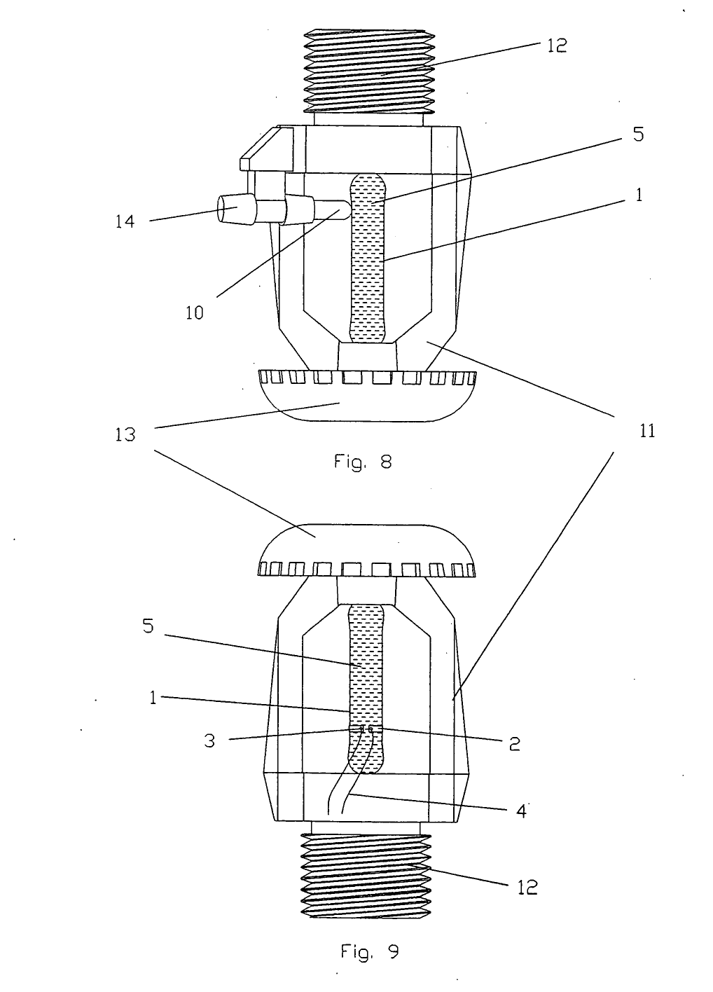

As a third embodiment of the arrangement of a glass tube sensor with means for detecting its condition, FIG. 6 depicts a thermal element 8 molded into the wall of the glass tube 1, and FIG. 7 depicts a resistance wire 9 molded into the wall of the glass tube 1. This variant, too, ensures a quick separation of the conductors 4 from its connectors 3 and, hence, an instantaneous signaling to the control center when the glass tube 1 bursts. The connection with the glass tube 1 can only be realized, however, during manufacture of new glass tubes 1.

Of course, every one of the mentioned means for sensing the state of the glass tube 1 may be utilized in every one of the three connections with the glass tube 1.

FIG. 1 depicts the possibility of mechanically engaging the glass tube 1 which is of advantage where the glass tube 1 is to be destroyed mechanically by a pressure plunger 10 as known from the prior art. The glass tube 1 is attached to a sprinkler housing 11 which may be threadedly connected, by a threaded stub 12, to a quench agent conduit (not shown). At its end opposite the threaded stub 12, the sprinkler is provided with an impact plate 13. The pressure plunger 10 which is also mounted on the housing 11 of the sprinkler is operatively connected to a pressure sensor 14. The pressure sensor 14 constantly registers the pressure of engagement between the pressure plunger 10 and the wall of the glass tube 1. As soon as the glass tube 1 bursts, the engagement pressure approaches nil. This signal is registered by the control center. As described in connection with the electrical variants, the glass vessel sensors in the vicinity of this sprinkler will be destroyed by their pressure plungers 10 so that they release their quench agent discharge openings. The advantage of this variant is that it requires no modifications of the glass vessel sensors, and that release of a glass vessel sensor causes destruction of the glass tube 1 only but not of its release elements such as the thermal element, heating or resistance wires. However, they cannot provide data about the development of the temperature in the room.

FIG. 9 depicts a sprinkler provided with an electrically actuable glass vessel sensor in accordance with the invention. As described in connection with FIG. 8, it consists of the housing 11 which in this case may be threadedly connected in an upright condition into the quench agent feed conduit. Accordingly, its impact plate 13 is disposed on top. The glass tube 1 is mounted in the housing 1 The heating element 2 is embracing the glass tube 1 as a sensor element of the kind described in connection with FIG. 1. It is connected to the control center (not) shown by its connections 3 and electrical conductors 4. A may be seen in all embodiments, the many self-releasing sprinklers have been converted with relatively small effort into sensors which can provide data about their condition as well as, in special embodiments, about the development of temperature in their vicinity.

What is claimed is:

1. A fire protection system with glass vessel sensors consisting of a liquid-filled glass vessel rigidly mounted in a housing and destructible by a control unit by electrical remote control,
characterized by the fact
that the electrical remote control is constituted as a sensor for detecting the condition of the glass vessel (1).

2. The fire protection system of claim 1,
characterized by the fact
that the sensor for detecting the condition of the glass vessel (1) is a heating element (2).

3. The fire protection system of claim 1,
characterized by the fact
that the sensor for detecting the condition of the glass vessel (1) is a unitary heating element and a temperature sensor.

4. The fire protection system of claim 3,
characterized by the fact
that the sensor for detecting the condition of the glass vessel (1) is a thermal element (6, 8).

5. The fire protection system of claim 3,
characterized by the fact
that the sensor for detecting the condition of the glass vessel (1) is a resistance heating wire (9).

6. The fire protection system of claim 1[to 5],
characterized by the fact
that the sensor for detecting the condition of the glass vessel (1) is placed around the exterior of the glass vessel (1).

7. The fire protection system of claim 1 [to 5],
characterized by the fact
that the sensor for detecting the condition of the glass vessel (1) is provided in the interior of the glass vessel (1) and that its connections (3) are fed through the wall of the glass vessel (1).

8. The fire protection system of claim 1 [to 5],
characterized by the fact
that the sensor for detecting the condition of the glass vessel (1) is integrated in the wall of the glass vessel (1).

9. The fire protection system of claim 1,
characterized by the fact
that the sensor for detecting the condition of the glass vessel (1) is a mechanical pressure sensor (14) movable against the glass vessel (1).

10. The fire protection system of claim 9,
characterized by the fact
that the mechanical pressure sensor (14) is operatively connected to a pressure plunger (10) also suitable for the mechanical destruction of the glass vessel (1).
